(19) United States
(12) Patent Application Publication
(10) Pub. No.: US 2020/0311701 A1
(43) Pub. Date: Oct. 1, 2020

(54) TRANSACTION ASSISTANCE SYSTEM

(71) Applicant: DEALMAKER PLAYBOOK, INC., San Luis Obispo, CA (US)

(72) Inventors: Alex Minicucci, San Luis Obispo, CA (US); Brian Kelly, Morro Bay, CA (US); Martin Hansen, Bakersfield, CA (US)

(21) Appl. No.: 16/365,503

(22) Filed: Mar. 26, 2019

(51) Int. Cl. G06Q 20/08; G06Q 20/32; G06Q 20/40

(52) U.S. Cl. CPC G06Q 20/0855; G06Q 20/405; G06Q 20/3223; G06Q 20/3255

(57) ABSTRACT

Methods and systems are described for automatically communicating transaction steps to users, and confirming completion of the transaction steps. The methods and systems may include receiving a transaction category, retrieving all transaction step activities and suggested transaction step activities of the transaction category, transmitting the retrieved transaction step activities and suggested transaction step activities through a network to a buyer and to a seller. The responses may include a transaction response, and an ignore indicator for each transaction step. The method may then include storing the transaction responses in a responses database, and updating the transaction step activities in a transaction steps database. The method may also include reviewing the transaction steps database and re-categorizing transaction step activities.

### BACKGROUND OF THE INVENTION

### 1. Field of the Invention

The present invention relates generally to facilitating transactions, and more specifically to automatically communicating transaction steps to users, and confirming completion of the transaction steps.

### 2. Discussion of the Related Art

Various systems and processes are known in the art for facilitating transactions. When performing a complicated business transaction, many steps and substeps may be required before the transaction is complete. Tracking these steps may require a significant amount of manual effort, and manually monitoring the progress of a transaction may result in errors. Therefore, there is a need for processes and tools to facilitate automatic tracking of a transaction process.

### SUMMARY

A method for automatically communicating transaction steps to users, and confirming completion of the transaction steps is described. The method may include receiving a transaction category, retrieving all transaction step activities and suggested transaction step activities of the received transaction category, transmitting the retrieved transaction step activities and suggested transaction step activities through the network to a buyer client when the buyer indicator is present and to a seller client when the seller indicator is present, collecting responses from the buyer client and the seller client, wherein the responses include a transaction response, and further wherein the responses include an ignore indicator for each transaction step, storing the transaction responses in the responses database, updating the transaction step activities in the transaction steps database with a number of times the ignore indicator has been set true, reviewing the transaction steps database comprising evaluating the number of times the ignore indicator has been set true for each of the plurality of transaction step activities and re-categorizing transaction step activities of the transaction category to the suggested transaction category when the number of times the ignore indicator has been set true exceeds a threshold number.

An apparatus for facilitating transactions is described. The apparatus may include a transaction processor, memory in electronic communication with the processor, and instructions stored in the memory. The instructions may be operable to cause the processor to receive a transaction category, retrieve all transaction step activities and suggested transaction step activities of the received transaction category, transmit the retrieved transaction step activities and suggested transaction step activities through the network to a buyer client when the buyer indicator is present and to a seller client when the seller indicator is present, collect responses from the buyer client and the seller client, wherein the responses include a transaction response, and further wherein the responses include an ignore indicator for each transaction step, store the transaction responses in the responses database, and update the transaction step activities in the transaction steps database with a number of times the ignore indicator has been set true.

A non-transitory computer readable medium storing code for facilitating transactions is described. In some examples, the code comprises instructions executable by a processor to: receive a transaction category, retrieve all transaction step activities and suggested transaction step activities of the received transaction category, transmit the retrieved transaction step activities and suggested transaction step activities through the network to a buyer client when the buyer indicator is present and to a seller client when the seller indicator is present, collect responses from the buyer client and the seller client, wherein the responses include a transaction response, and further wherein the responses include an ignore indicator for each transaction step, store the transaction responses in the responses database, and update the transaction step activities in the transaction steps database with a number of times the ignore indicator has been set true.

A system is described for communicating transaction steps to users, and confirming completion of the transaction steps, the system comprising: a transaction steps database comprising a plurality of transaction step activities, each transaction step activity comprising at least one transaction category or suggested transaction category, and further comprising at least one of a buyer indicator or a seller indicator; a responses database comprising a plurality of transaction responses; a network coupled to the transaction steps database and the response database; and a transaction processor coupled to the network configured to execute the following steps: receiving a transaction category, retrieving all transaction step activities and suggested transaction step activities of the received transaction category, transmitting the retrieved transaction step activities and suggested transaction step activities through the network to a buyer client when the buyer indicator is present and to a seller client when the seller indicator is present, collecting responses from the buyer client and the seller client, wherein the responses include a transaction response, and further wherein the responses include an ignore indicator for each transaction step, storing the transaction responses in the responses database, and updating the transaction step activities in the transaction steps database with a number of times the ignore indicator has been set true. The system may also include a transaction refiner coupled to the network and configured to review the transaction steps database comprising evaluating the number of times the ignore indicator has been set true for each of the plurality of transaction step activities and re-categorize transaction step activities of the transaction category to the suggested transaction category when the number of times the ignore indicator has been set true exceeds a threshold number.

Some examples of the method, apparatus, non-transitory computer readable medium, and system described above may further include receiving a new transaction step activity from the buyer client or the seller client, the new transaction step activity comprising at least one of the buyer indicator or the seller indicator, and the received transaction category.

Some examples of the method, apparatus, non-transitory computer readable medium, and system described above may further include transmitting the new transaction step activity through the network to a buyer client when the buyer indicator is present and to a seller client when the seller indicator is present. Some examples of the method, apparatus, non-transitory computer readable medium, and system described above may further include collecting a response to the new transaction step activity from at least one of the buyer client and the seller client, wherein the response includes a transaction response. Some examples of the method, apparatus, non-transitory computer readable medium, and system described above may further include storing the transaction response in the responses database.

Some examples of the method, apparatus, non-transitory computer readable medium, and system described above may further include removing transaction step categories of the suggested transaction category when the number of times the ignore indicator has been set true exceeds another threshold number from the transaction steps database.

In some examples of the method, apparatus, non-transitory computer readable medium, and system described above, the network comprises an instant messaging network. In some examples of the method, apparatus, non-transitory computer readable medium, and system described above, the network comprises the internet. In some examples of the method, apparatus, non-transitory computer readable medium, and system described above, the network is configured to provide notifications for a mobile device. In some examples of the method, apparatus, non-transitory computer readable medium, and system described above, the network comprises a short message service (SMS) network.

### BRIEF DESCRIPTION OF THE DRAWINGS

FIG. 1 shows an example of a transaction system in accordance with aspects of the present disclosure.

FIGS. 2 through 3 show examples of a process for automatically communicating transaction steps to users, and confirming completion of the transaction steps in accordance with aspects of the present disclosure.

FIG. 4 shows an example of a process for facilitating transactions in accordance with aspects of the present disclosure.

FIG. 5 shows an example of a process for presenting and selecting activities in accordance with aspects of the present disclosure.

FIG. 6 shows an example of a process for adding tasks to a suggested list in accordance with aspects of the present disclosure.

FIG. 7 shows an example of a process for responding to ignored tasks in accordance with aspects of the present disclosure.

FIG. 8 shows an example of a process for using a transaction system in accordance with aspects of the present disclosure.

FIG. 9 shows an example of a transaction map for offers in accordance with aspects of the present disclosure.

### DETAILED DESCRIPTION

The present disclosure relates to facilitating business transactions. When performing a complicated business transaction, many steps and substeps may be required before the transaction is complete. Tracking these steps may require a significant amount of manual effort, and manually monitoring the progress of a transaction may result in errors. Thus, there is a need for processes and tools to facilitate automatic tracking of a transaction process.

The present disclosure describes systems and methods for generating transaction maps, and for facilitating easy structuring and tracking of deal completion. Embodiments of the present disclosure relate to automated learning methods for identifying and categorizing transaction step activities. Thus, users may be guided through a business transaction in an efficient manner without the need for manually constructing every transaction map.

The following terms are used throughout the present disclosure:

Transaction: The process, from start to finish, of selling a business, comprised of a series of Steps and corresponding Activities, completed, or ignored by both parties.

Transaction Map: The Transaction Map is the result of the Activity List getting modified based on user input, which will customize the Activity List to the specific needs of transaction.

Activity list: This is the baseline or static list that every user starts out with. There is one for each vertical.

Suggested Activities List: A queue that holds Activities. If these are added by multiple users in different transactions, then the Activity will move from the Suggested Activities list to the Activity list. If these are never added by users, they will be forgotten by the list.

Activity: Activities are user-driven tasks. These can be as simple as a reminder to do an meanial task, or contain a file upload or template documents. Activities during a transaction are passed between the buyer and seller. Activities may also be referred to as tasks throughout this document.

Complete an Activity: Activities are marked as complete by the user checking the green box. This signals that the user has completed the contents of the activity.

Ignore an Activity: Set an Activity's status as “ignore” hides the activity from view and signals that the activity isn't relevant to the transaction.

Step: A Step is a collection of Activities. Steps may unlock linearly. Unlock Steps by completing or ignoring every activity within the Step.

The present disclosure is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

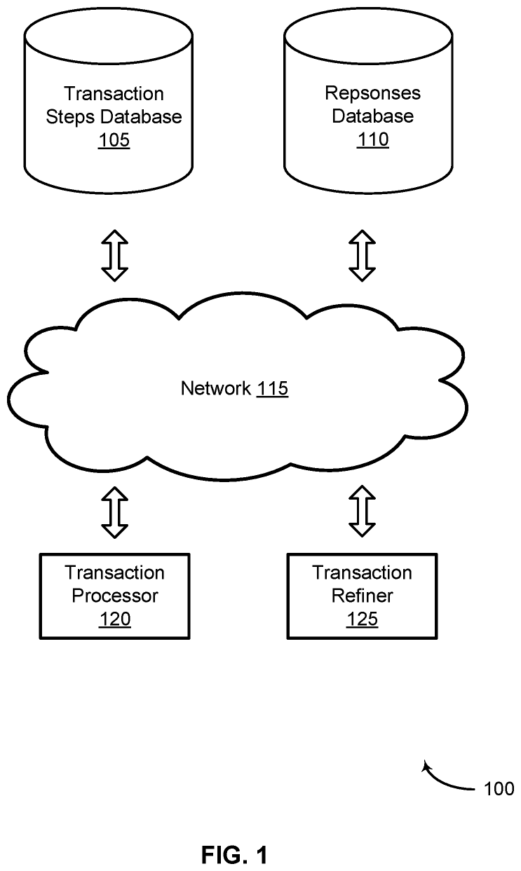

FIG. 1 shows an example of a transaction system 100 in accordance with aspects of the present disclosure. Transaction system 100 may be used to help users walk through a transaction such as a process of selling a business.

Transaction system 100 may operate based on a model of business transactions. For example, a business process may be broken down into several steps, which are combined in a transaction map. Each major step may include list of activities. Transaction system 100 may monitor progress through a business transaction by ensuring that all activities in a step must be either marked as completed or marked as ignored. Once all activities in a step have been marked as completed or ignored, the next step will be unlocked.

In some embodiments, each vertical may have its own default list of steps and activities. These activities are the most common activities that a business in its vertical is likely to encounter during a transaction.

When a user creates a new transaction, the default Activity List may be selected from the system based on the vertical of the business. The user will answer a series of questions during setup, which will further customize the Activity List, creating a custom Transaction Map. For example, if the user answers that they do not have a physical location, then we will remove all activities that relate to having a physical location.

During the transaction, either party (buyer or seller) may either add or ignore activities. If a user adds an activity, the user will immediately be able to work with and use that activity in their transactions. However, the activity will concurrently be added to an admin queue. In some cases, an admin may ensure that the activity is appropriate and then approve or deny the activity to be added to the Suggested Activities list. If approved, the activity is then added to the Suggested Activities list.

The next time a user creates a transaction within that vertical, the Suggested Activities list will be presented as a way to customize the Transaction Map. The assumption here is that the previously added Activity may be a common Activity for that vertical, and could possibly be necessary for every transaction moving forward.

If future users add the suggested activity to their list, for example, three times, then the activity is put on the Activity List for all future users in that vertical. Essentially, that activity becomes part of the static Activity List for that vertical moving forward.

The Suggested Activities feature may keep count of the number of times an activity is added from the list and the number of times that an activity is not added from the list. Activities that aren't added by enough users to validate their importance in a transaction will be eventually erased from the list.

When a user ignores an activity, the system may ask for further input from the user. The user will be asked why they are ignoring the activity and presented with the options: 1) this activity doesn't apply to this industry or type of business; 2) this doesn't apply to my business; 3) Other.

If enough users answer “This activity doesn't apply to the industry or business type,” then the activity may be demoted to the Suggested Activities list. If there is no answer or the user answers that it doesn't apply to their specific transaction, then the Activity may remain on the default Activity List.

The result is that the activity list may change over time as a direct result of user input to the system. This further customizes each vertical's Activity List through time, keeping up with the different nuances of each type of transaction.

For example, a system may start with a set of predefined steps and activities (e.g., by business category), and then evolve automatically over time based on actual transactional data and habits which will add or remove activities on any step, thus improving and refining the user experience the more the system is utilized over time.

In another example, the system will adapt over time by learning what activities and steps should be added or removed automatically based on prior transactional history and other user inputs. This will improve the experience for future users, making the system “smarter” over time without human intervention.

The learning may take place using an artificial neural network (ANN). For example, data and meta-data about the step may be used as input, while feedback about the usage of the steps (i.e., whether and why they are selected or ignored) may be used as target data for training an ANN.

An ANN may be a hardware or a software component that includes a number of connected nodes (a.k.a., artificial neurons), which may be seen as loosely corresponding to the neurons in a human brain. Each connection, or edge, may transmit a signal from one node to another (like the physical synapses in a brain). When a node receives a signal can process it and then transmit the processed signal to other connected nodes. In some cases, the signals between nodes comprise real numbers, and the output of each node may be computed by a function of the sum of its inputs.

Each node and edge may be associated with one or more node weights that determine how the signal is processed and transmitted.

During the training process, these weights may be adjusted to improve the accuracy of the result (i.e., by minimizing a loss function which corresponds in some way to the difference between the current result and the target result). The weight of an edge may increase or decrease the strength of the signal transmitted between nodes. In some cases, nodes may have a threshold below which a signal is not transmitted at all. The nodes may also be aggregated into layers. Different layers may perform different transformations on their inputs. The initial layer may be known as the input layer and the last layer may be known as the output layer. In some cases, signals may traverse certain layers multiple times.

Transaction system 100 may include features configured to facilitate business transactions, including but not limited to:

Easy Sign Up. Sign up information is collected and processed in a streamlined manner. The user may be asked a few short questions using a chatbot, wizard, webform or other method to set up their dashboard and notifications. These questions may be broad in scope. For example: “Are you interested in buying or selling a company?” The answers to the chatbot questions will funnel the user into the appropriate user dashboard

Introduction to Software. The transaction system 100 may include introductory short videos on what the system does including videos on how to use software for each step. The system may also include short click-throughs on software use modes: i.e., user can activate “Assisted” or “Master” mode, and can change in or out of either mode at any time. The user may choose the appropriate operation mode.

Different Operational Modes. The user may pick the mode they wish to operate the system in, either Assisted or Master. In “DealMaker Mode,” the system may be more reactive than proactive (i.e. it doesn't offer explanations and conversation type help unless the user clicks the help icons. In “Playbook Mode,” pop up boxes walk the user through each step helping the user understand and execute tasks and deliverables, motivating them to push their deal to a close.

Customized Dashboards Determined by User Type. Each type of user may have a custom dashboard, such as Paid Sellers (a Full Seller Dashboard that has all the bells and whistles the system offers a paid seller), Paid Buyers (a Full Buyer Dashboard that has all the bells and whistles the system offers a paid buyer), Paid User Team Member (a user invited by Paid Buyer or Paid Seller may have a Custom

Dashboard that allows the team member to view transaction progress, collaborate with team members, review, and upload information, execute tasks, create due diligence lists & utilize useful tools to move deals forward to a close), Free Buyer or Free Sellers (a Buyer or Seller Dashboard that moves the user through a strict, streamlined process, allowing them to collaborate with team members, execute NDAs, review, and upload information, execute tasks, creating due diligence lists, and close deals, and Free Buyer Team Member (a Custom Dashboard that allows the team member to view transaction progress, collaborate with team members, review, and upload information, execute tasks, and create due diligence lists).

Step-by-Step Process. A streamlined process provides guidance on how to sell or buy a business, depending on the user type, depending on the user's circumstances (i.e. the seller already has a buyer, the system streamlines the process, removing, or marking complete steps not applicable to their situation. The system may have an easy to use, visually pleasing dashboard that puts moving the deal forward a priority, letting the user easily know where they are in the process. The user can move forward through the steps with unfinished tasks in the previous steps. The system may remind the user of the unfinished tasks when they login, giving them the opportunity to revisit the task, mark it n/a or come back to it later.

Communication System. The user can use a chat feature in the system to talk to buyers or team member that are signed on at the time they are in the system. The user can use an internal email system to send deal related messages back and forth. Users may be notified when a new message is received via email or text. The system generates automatic emails to related parties when milestones are achieved or meaningful activity has happened.

Business Profiles. Business profile information may be stored in the system and feeds marketing materials. Business Profile information can be linked to 3rd party sites to auto populate fields needed to register for their service.

Buyer Marketing Documents. The transaction system 100 may create or offer templates based on Buyer Profiles.

Seller Marketing Documents. The transaction system 100 may create or offer templates for Blind Seller Profiles, Detailed Seller Profiles, Online Marketing Websites, and Executive Summaries.

Team Member Collaboration. A user can invite a team member at any time throughout the transaction. The interaction is easy to find and prompted by the software, making the invitation process easy. The inviting user's type (buyer/seller) may determine the type of permissions the invited user may have access to i.e. a seller can invite a team member, or an invited buyer. An invited buyer can only invite a team member. Team members may add and complete tasks and monitor the transaction in the same way that a seller or buyer does.

Deal Team Contact Database. Users may have a deal team contact list, making access to contact information for all parties available in one place.

Buyer Contact Tracker System. Potential buyers contact information and conversation history can be tracked in one simple contact management system. Simple “Buyer Status Reports” can be pulled showing what status each buyer is in, such as No Contact, Working, Expecting NDA, Reviewing Opportunity, Expecting Term Sheet, Executed Term Sheet, Out—Executed NDA, Out—No Interest, or Out—No Response. Users can “ping” a potential buyer after a certain period of time to ascertain their continued level of interest if buyer has not responded after 15 days. A user can build a potential buyer list by manually entering their contact information into the system, or they can upload to the system using a CSV excel spreadsheet. The system uses field mapping to make sure the spreadsheet is uploaded correctly.

Seller Contact Tracker System. Potential buyers contact information and conversation history can be tracked in one simple contact management system. Simple “Buyer Status Reports” can be pulled showing what status each buyer is in: No Contact, Working, Executed NDA, Reviewing Data Room, Expecting Term Sheet, Executed Term Sheet, Out—Executed NDA, Out—No Interest, or Out—No Response. Users can “ping” a potential seller after a certain period of time to ascertain their continued level of interest if seller has not responded in 15 days. A user can build a potential seller list by manually entering their contact information into the system, or they can upload to the system using a CSV excel spreadsheet. The system uses field mapping to make sure the spreadsheet is uploaded correctly.

Tasks (Activities). Task fields may include: Name of Task, Category (Preparation, Due Diligence, Close, Post-Close), Person Assigned (defaults to creator), Date Due, Importance, and Notes. Tasks can be assigned to team members and invited buyer/sellers. The system tracks open items, items that are time sensitive and need to be completed by a certain date; and who is responsible for what items. Users can send tasks updates to responsible parties reminding them of their open tasks, or they can set the system to send out weekly reminders. Tasks can be generated by clicking on the suggested tasks the system suggests to populate the specific list (Preparation, Due Diligence, Close, Post-Close), manually entered and/or uploaded the tasks using a CSV spreadsheet.

Preparation Task List. Users can select items from the preparation task list suggestions to help build their preparation task list. Tasks in this list are specific to prepare documentation, facility preparation and team member communication and collaboration, finding a buyer and preparing documentation to help move the sale forward

Due Diligence Task List. Users can select items from the due diligence task list suggestions to help build their due diligence task list. They may only select items they have available and that apply to their company. This keeps the list simple and streamlined, removing clutter. Each category has suggested tasks the user can click on to add to their list. The buyer may have full access to this feature, letting them create the due diligence task list, requesting only the items that are of interest to their review. Included in these task lists may be a separate comprehensive real property profile with accompanying documentation list

Closing Schedule Task List Category. This category lists the items that need to be completed or delivered to close the transaction. Often the attorneys on both sides may generate this list depending on what the transactional documents call for. This feature is fully available to both buyer and seller.

Transition Schedule Task List Category. This category lists the items that need to be completed after the transaction has closed. Sometimes items that originally were thought to be closing items are pushed “postclose”. To do this, the user simple changes that tasks category. The attorneys are a big part of creating the transition list. They may use the stipulated components of the Purchase and Sale Agreement to drive the post-close items. The buyer and seller may also drive the transition task list depending on how they plan to deal with the employee matters, customer matters and administration (bank accounts, utilities, etc.) matters, along with others.

Virtual Data Rooms (VDR). Documentation may be kept in the system is customizable data rooms. The user may have several VDRs, one for their personal use to upload documents, and store information on buyers; one for the potential buyers to review after they execute an NDA, and one for final due diligence or closing. Information is easily shared with buyers and team members. A seller can view analytics, showing who has reviewed or downloaded or uploaded what documents, and when the action was taken. The

Seller can give permissions to users in the VDR. They can check any or all of the options: viewer, downloader, uploader, or all.

Buyer Qualification. The transaction system 100 may help qualify the potential buyers by asking the buyers a series of questions and requesting qualifying information from the seller feels the time is right. The seller may click the “Qualify Buyer” button, which may allow the system to request activate a chatbot to ask certain questions to be answered by the potential buyer This is done automatically, with the results delivered to the seller in the form of a buyer profile.

Customizable Seller Qualification Process. The buyer uses this tool to set up how he wants to treat the interaction with sellers in the system. At this time, the buyer has a choice on what is requested of the invited seller, when and what process they may be put through. For example: a buyer chooses his potential sellers to: Invite to system, Review buyer's information, Offer to execute NDA to make them feel more comfortable sharing information, Request conference call, Request initial company information, Prepare Term Sheet, Enter Due Diligence, Request due diligence deliverables, Close Transaction, or Transition Company. Any of these can be “unchecked” then potential sellers may skip that step.

Business Valuation Tool. The transaction system 100 may provide a simple valuation tool with industry standard multiples in a drop-down type menu. This may allow the user to get a viable purchase price range. It may also provide a link to a third-party valuation site for a “second opinion.”

Term Sheet/Letter of Intent Guidance. The transaction system 100 may provide term sheet/ negotiation guidance by pops up boxes or short videos teaching the user how to structure a term sheet and how to negotiate a deal. If the user has a term sheet they prefer to use, they simply click a box, allowing them to upload their document to the system in place of the system's Term Sheet.

Term Sheet Tool. The transaction system 100 may give the user a variety of components the user can select to create their term sheet, and the user can add their owner custom components. Once the components are selected and customized components added, the user may click a button, generating a Term Sheet or LOI, depending on their choice that can be sent through the system or downloaded. If a user doesn't want to use the system generated term sheet or LOI, they can download an example Term Sheet or Letter of Intent for their own use, then upload to the system once complete.

Tax Implication/Liability Checklist. The transaction system 100 may have a Tax section that allows the user's accountant to enter his assumptions for the tax implication and liability.

Asset Checklist. The transaction system 100 may have a Tax section that allows the user's lawyer and accountant to enter his applicable information related to the assets.

Transaction Templates and Example Documents. The transaction system 100 may provide various transactional document templates for the user to customize. They may be downloadable, in a format the user can manipulate, then once customized, upload and shared with their team and buyer. The system may allow the user or his team member(s) to upload their own transactional documents in place of the templates the system offers. Some of the preparation request items and due diligence items may offer examples for the user to view. If an example is available, the system may have a button that allows the user to “click to see an example of this item.”

Data Vault. Downloadable templates available to the users may be stored in a Data Vault. The system may provide templates for due diligence deliverable. The system may provide templates for term sheets and letter of intent. The system may provide templates for transactional documents i.e. Asset Purchase and Sale Agreement. The system may provide white papers on transactional related items. The system may provide how-to videos on various topics of interest to the seller, buyer, and their teams.

Gross Consideration Calculator. The transaction system 100 may provide a gross consideration calculator to analyze term sheets & offers, and final deal total consideration.

Zip File or Binder of Final Deal Documentation. Once a transaction is complete, the system may provide an option to request a zip file of all the information generated throughout the “deal”.

Notifications. The transaction system 100 may offer users suggestions on how to keep the deal on track. It may do this by looking at the date the user has entered in the initial set-up process. The system may notify the user of outstanding or unfinished tasks that need to be completed to move their deal forward. The system may notify the seller when a non-disclosure agreement has been signed. The system may notify the seller when a term sheet has been signed or if the user has checked the box that they have acquired a signed terms sheet. The system may notify the seller when a buyer makes a request, asks a question, downloads or views an item in the Virtual Data Room, or sends a message. The system may notify the buyer when a seller makes a request, asks a question, or adds items to the Virtual Data Room.

Other Platform Highlights. The transaction system 100 may provide for other features such as security (i.e., the system may offer superior security, so their users are confident that uploading their sensitive, personal information is safe), social media registration (i.e., when the user signs up, they may have the option of using their social media credentials to auto populate some of the registration fields), instant updating (i.e., when the seller, buyer, and team members are logged in at the same time, changes they make are visible to other users without the user having to refresh), auto-Saving (i.e., the system may auto-save any data points that the users have changed, so the user doesn't lose any data or progress if their internet connection breaks or the user forgets to sign off), Drag & Drop (i.e., to upload documents and other information to the system, the user can use an upload button, or use drag and drop), simple navigation (i.e., the system may offer its users simple navigation making it obvious what to press to get to the next step - complete buttons, next buttons, go back buttons, etc.), third party buy/sell sites (i.e., the system may work with online buy sell sites to auto-populate their fields, and rout their emails to the system).

Transaction system 100 may include transaction steps database 105, responses database 110, network 115, transaction processor 120, and transaction refiner 125.

Transaction steps database 105 may include transaction step activities. Transaction step activities may include transaction category and party indicator.

In some examples, the network 115 comprises an instant messaging network. In some examples, the network comprises the internet. In some examples, the network is configured to provide notifications for a mobile device. In some examples, the network comprises a short message service (SMS) network.

Transaction processor 120 receives a transaction category and retrieves all transaction step activities and suggested transaction step activities of the received transaction category. Transaction processor 120 may also transmit the retrieved transaction step activities and suggested transaction step activities through the network 115 to a buyer client when the buyer indicator is present and to a seller client when the seller indicator is present. Transaction processor 120 also collects responses from the buyer client and the seller client, wherein the responses include a transaction response and further wherein the responses include an ignore indicator for each transaction step. Transaction processor 120 also stores the transaction responses in the responses database and updates the transaction step activities in the transaction steps database 105 with a number of times the ignore indicator has been set true.

Transaction processor 120 may also receive a new transaction step activity from the buyer client or the seller client, the new transaction step activity comprising at least one of the buyer indicator or the seller indicator, and the received transaction category. Transaction processor 120 may also transmit the new transaction step activity through the network 115 to a buyer client when the buyer indicator is present and to a seller client when the seller indicator is present.

Transaction processor 120 may also collect a response to the new transaction step activity from at least one of the buyer client and the seller client, wherein the response includes a transaction response. Transaction processor 120 may also store the transaction response in the responses database. Transaction processor 120 may also remove transaction step categories of the suggested transaction category when the number of times the ignore indicator has been set true exceeds another threshold number from the transaction steps database 105.

A transaction processor 120 may include an intelligent hardware device, (e.g., a general-purpose processing component, a digital signal processor (DSP), a central processing unit (CPU), a microcontroller, an application specific integrated circuit (ASIC), an field programmable gate array (FPGA), a programmable logic device, a discrete gate or transistor logic component, a discrete hardware component, or any combination thereof). In some cases, the transaction processor may be configured to operate a memory array using a memory controller. In other cases, a memory controller may be integrated into the processor. The processor may be configured to execute computer-readable instructions stored in a memory to perform various functions.

Transaction refiner 125 reviews the transaction steps database 105 by evaluating the number of times the ignore indicator has been set true for each of the plurality of transaction step activities. Transaction refiner 125 also re-categorizes transaction step activities of the transaction category to the suggested transaction category when the number of times the ignore indicator has been set true exceeds a threshold number.

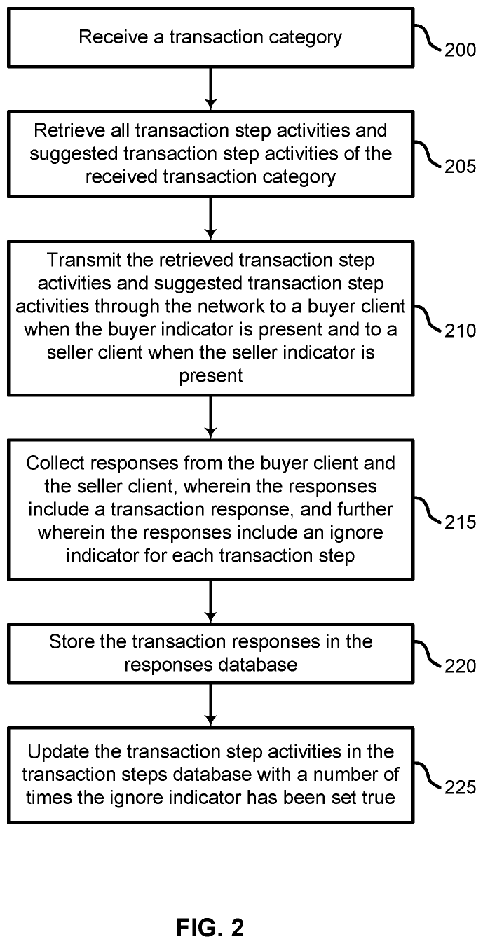

FIG. 2 shows an example of a process for automatically communicating transaction steps to users, and confirming completion of the transaction steps in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps or may be performed in conjunction with other operations described herein.

At step 200, the system may receive a transaction category. In some cases, the operations of this step may refer to, or be performed by, a transaction processor as described with reference to FIG. 1.

At step 205, the system may retrieve all transaction step activities and suggested transaction step activities of the received transaction category. In some cases, the operations of this step may refer to, or be performed by, a transaction processor as described with reference to FIG. 1.

At step 210, the system may transmit the retrieved transaction step activities and suggested transaction step activities through the network to a buyer client when the buyer indicator is present and to a seller client when the seller indicator is present. In some cases, the operations of this step may refer to, or be performed by, a transaction processor as described with reference to FIG. 1.

At step 215, the system may collect responses from the buyer client and the seller client, wherein the responses include a transaction response, and further wherein the responses include an ignore indicator for each transaction step. In some cases, the operations of this step may refer to, or be performed by, a transaction processor as described with reference to FIG. 1.

At step 220, the system may store the transaction responses in the responses database. In some cases, the operations of this step may refer to, or be performed by, a transaction processor as described with reference to FIG. 1.

At step 225, the system may update the transaction step activities in the transaction steps database with a number of times the ignore indicator has been set true. In some cases, the operations of this step may refer to, or be performed by, a transaction processor as described with reference to FIG. 1.

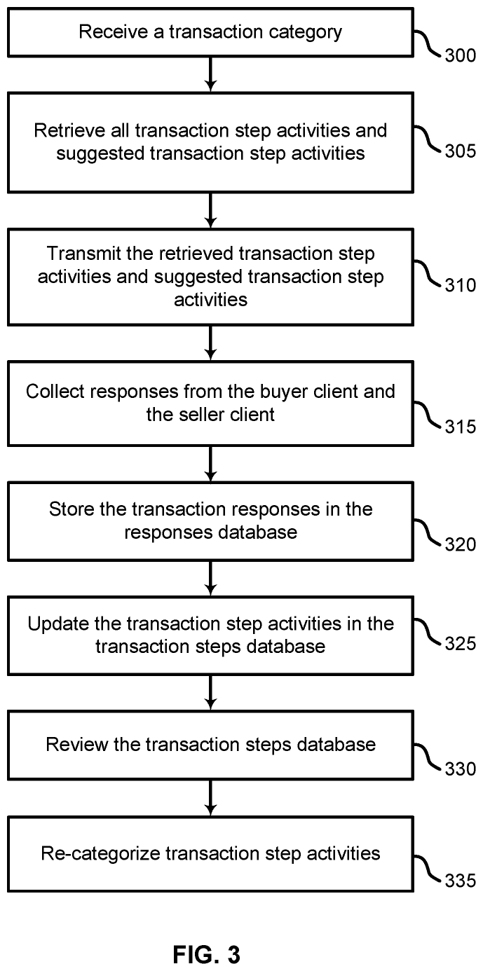

FIG. 3 shows an example of a process for automatically communicating transaction steps to users, and confirming completion of the transaction steps in accordance with aspects of the present disclosure. FIG. 3 includes steps that may be performed by a transaction processor as well as steps that are performed by a transaction refiner.

In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps or may be performed in conjunction with other operations described herein.

At step 300, the system may receive a transaction category. In some cases, the operations of this step may refer to, or be performed by, a transaction processor as described with reference to FIG. 1.

At step 305, the system may retrieve all transaction step activities and suggested transaction step activities of the received transaction category. In some cases, the operations of this step may refer to, or be performed by, a transaction processor as described with reference to FIG. 1.

At step 310, the system may transmit the retrieved transaction step activities and suggested transaction step activities through the network to a buyer client when the buyer indicator is present and to a seller client when the seller indicator is present. In some cases, the operations of this step may refer to, or be performed by, a transaction processor as described with reference to FIG. 1.

At step 315, the system may collect responses from the buyer client and the seller client, wherein the responses include a transaction response, and further wherein the responses include an ignore indicator for each transaction step. In some cases, the operations of this step may refer to, or be performed by, a transaction processor as described with reference to FIG. 1.

At step 320, the system may store the transaction responses in the responses database. In some cases, the operations of this step may refer to, or be performed by, a transaction processor as described with reference to FIG. 1.

At step 325, the system may update the transaction step activities in the transaction steps database with a number of times the ignore indicator has been set true. In some cases, the operations of this step may refer to, or be performed by, a transaction processor as described with reference to FIG. 1.

At step 330, the system may review the transaction steps database comprising evaluating the number of times the ignore indicator has been set true for each of the plurality of transaction step activities. In some cases, the operations of this step may refer to, or be performed by, a transaction refiner as described with reference to FIG. 1.

At step 335, the system may re-categorize transaction step activities of the transaction category to the suggested transaction category when the number of times the ignore indicator has been set true exceeds a threshold number. In some cases, the operations of this step may refer to, or be performed by, a transaction refiner as described with reference to FIG. 1.

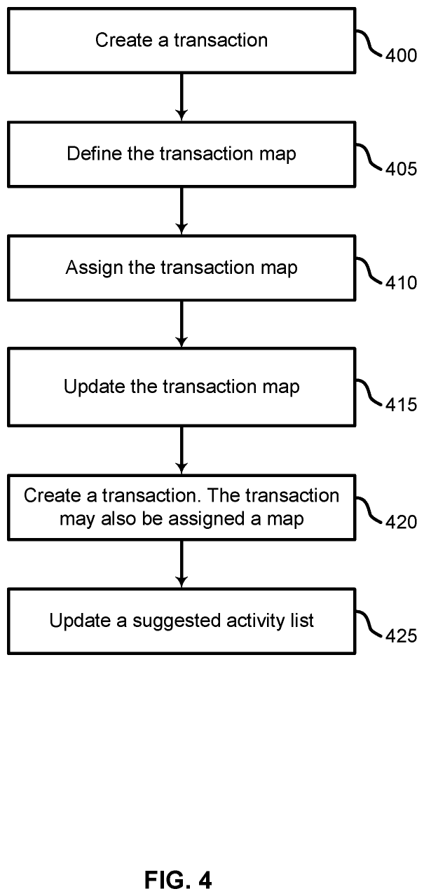

FIG. 4 shows an example of a process for facilitating transactions in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps or may be performed in conjunction with other operations described herein.

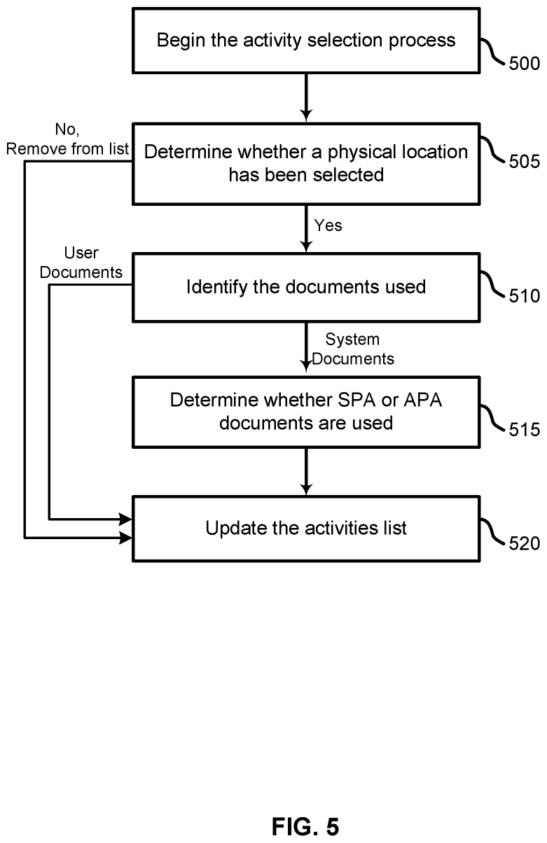

At step 400, a user may create a transaction. At step 405, the system may define the transaction map. For example, a user may be asked to choose a vertical and sub-vertical from a list, and this determines which Activity List the user gets. The user may also be asked whether they want to use system documents or use their own documents for drafting the asset purchase agreement (APA) or stock purchase agreement (SPA). If they choose to use their own documents, then the Activities with the AP or SP templates will be set to Ignored. If the user chooses to use their documents, they may upload the documents. The user is asked what type of transaction they will be making. Either an Asset Purchase or Stock purchase. This picks which templated documents the system includes for drafting the agreement. For example, APA assigns APA specific documents to the user, and SPA assigns SPA specific documents to the user. The user may also be asked if they have a Physical Location. Any Activities related specifically to a physical location are removed if the user answers no. The system may then present Suggested Activities for the user to select to add to Activity List. Further details regarding this process may be found with reference to FIG. 5.

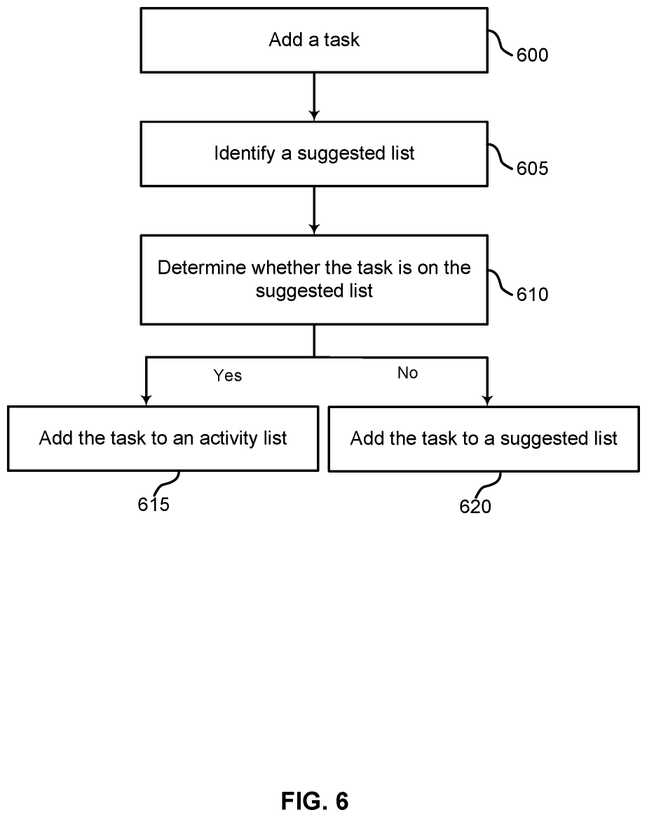

At step 410, the system may assign the transaction map. At step 415, the system may update the transaction map. Throughout the transaction, the user may either add an activity and or ignore an activity that is part of the transaction map. If the user adds an activity, the system puts the new content through a language filter to make sure that it does not contain vulgarities. The system may then puts the Activity in an admin queue where they can edit, approve, or deny. If approved, the Activity is added to the Suggested List. Further detail regarding this part of the process may be found with reference to FIG. 6.

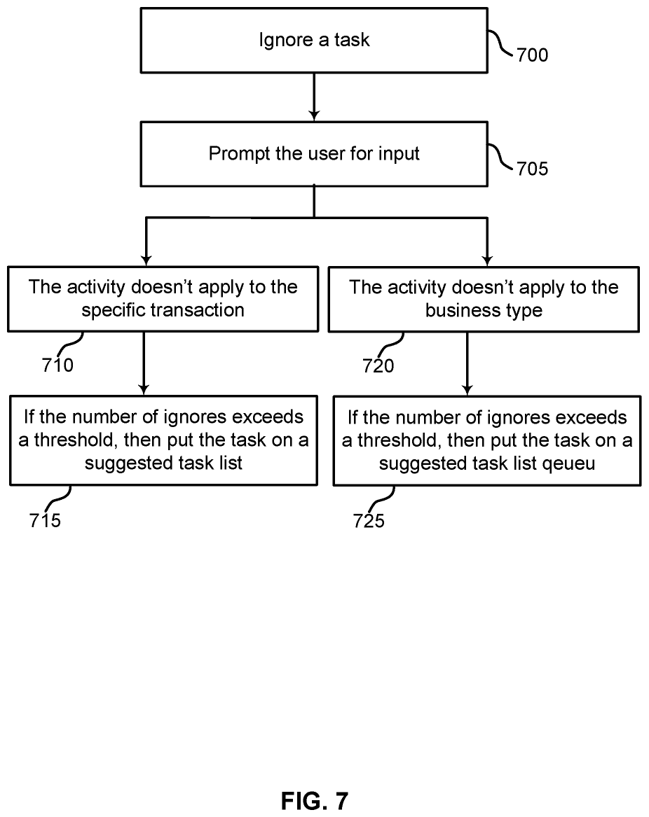

If the user Ignores an activity, the system may prompt the user for feedback regarding whether the activity may not apply to the industry or business type, or it may not apply to a specific transaction. If an activity is on a Suggested list, then the Activity may be removed after a certain number of ignores (i.e., if the number of ignores exceeds a threshold). If Activity is on a Transaction map, then it is removed after a certain number of ignores. Further detail regarding this part of the process may be found with reference to FIG. 7.

At step 420, the system may create a transaction. The transaction may also be assigned a map. At step 425, the system may update a suggested activity list. When creating a new transaction, the user may be presented with Suggested Activities to add to customize their Transaction map. When adding a custom Activity, the system will use also intuitively pull from the Suggested Activities list as suggestions. If a certain number of users select a suggested Activity in a vertical, then that Activity may be added to the transaction map. If a user ignores a previously ignored Activity, then it may be added to the suggested list.

FIG. 5 shows an example of a process for presenting and selecting activities in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps or may be performed in conjunction with other operations described herein.

At step 500, the system may begin the activity selection process.

At step 505, the system may determine whether a physical location has been selected. If yes, proceed to step 410. If not, remove the activities from the list (i.e., at step 420).

At step 510, the system may identify the documents used. If system documents are used, proceed to step 415. Otherwise, proceed to step 420 with the user documents.

At step 515, the system may determine whether SPA or APA documents are used.

At step 520, the system may update the activities list.

FIG. 6 shows an example of a process for adding tasks to a suggested list in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps or may be performed in conjunction with other operations described herein.

At step 600, the system may add a task. At step 605, the system may identify a suggested list. At step 610, the system may determine whether the task is on the suggested list. If yes, proceed to step 515. Otherwise, proceed to step 520. At step 615, the system may add the task to an activity list. At step 620, the system may add the task to a suggested list queue.

FIG. 7 shows an example of a process for responding to ignored tasks in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps or may be performed in conjunction with other operations described herein.

At step 700, a user may ignore a task on a transaction map. After the user has ignored the task, at step 705, the system may prompt the user for feedback regarding why the task was ignored.

At step 710, the user may respond that the activity does not apply to the specific transaction. The system may determine whether the number of ignores exceeds a threshold. If so, at step 715, the task may be removed (i.e., to a suggested task list).

At step 720, the user may respond that the activity does not apply to a business type. Then, the system may determine whether the number of ignores exceeds a threshold and, at step 725, remove the activity (i.e., to a suggested task list queue).

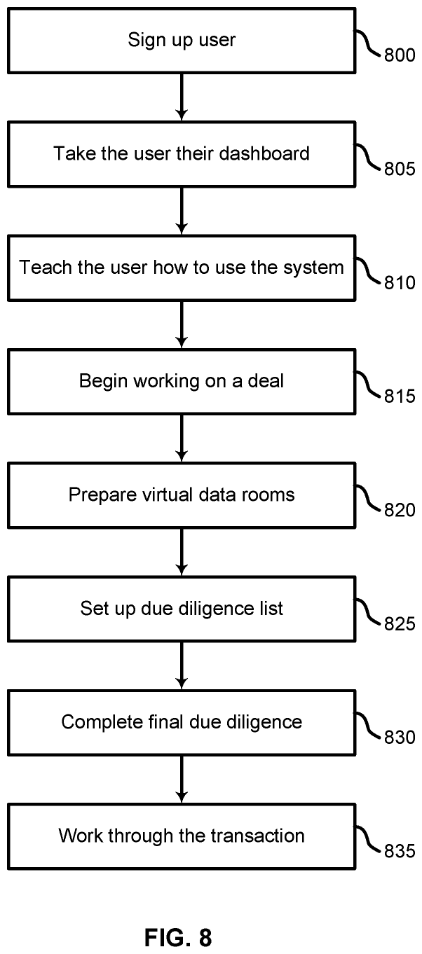

FIG. 8 shows an example of a process for using a transaction system in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps or may be performed in conjunction with other operations described herein.

At step 800, a user may sign up. In some cases, a chatbot, wizard, webform or other method then asks the new user questions so the system can customize their dashboard.

At step 805, the system may take the user their dashboard. The dashboard may be a simple, straightforward dashboard that offers easy to follow steps, tools and data storage.

At step 810, the system may teach the user how to use the system. For example, the user is introduced to the software, educated on how they can use it, then asked a couple of questions to complete set up of their system. At this time they may also choose their mode (i.e., “DealMaker” or “Playbook” or “Master” mode). The system determines how the software interacts with the user. The “DealMaker” is the user in charge of running their deal.

At step 815, the user may begin working on a deal. For example, the user prepares for their purchase or sale.

At step 820, the system may prepare virtual data rooms. In some cases, the user or the system finds buyers or sellers and launches a campaign. Meanwhile, the user may negotiate and execute a Term Sheet.

At step 825, the system may set up due diligence list. Both sides work through due diligence, draft transaction documents and plan for the close.

At step 830, the user and the system may complete the final due diligence process. In some cases, the deal closes, documents are signed, and both parties begin the transition process.

At step 835, the system may work through the transaction. In some cases, final transaction documents are stored, and the deal is complete.

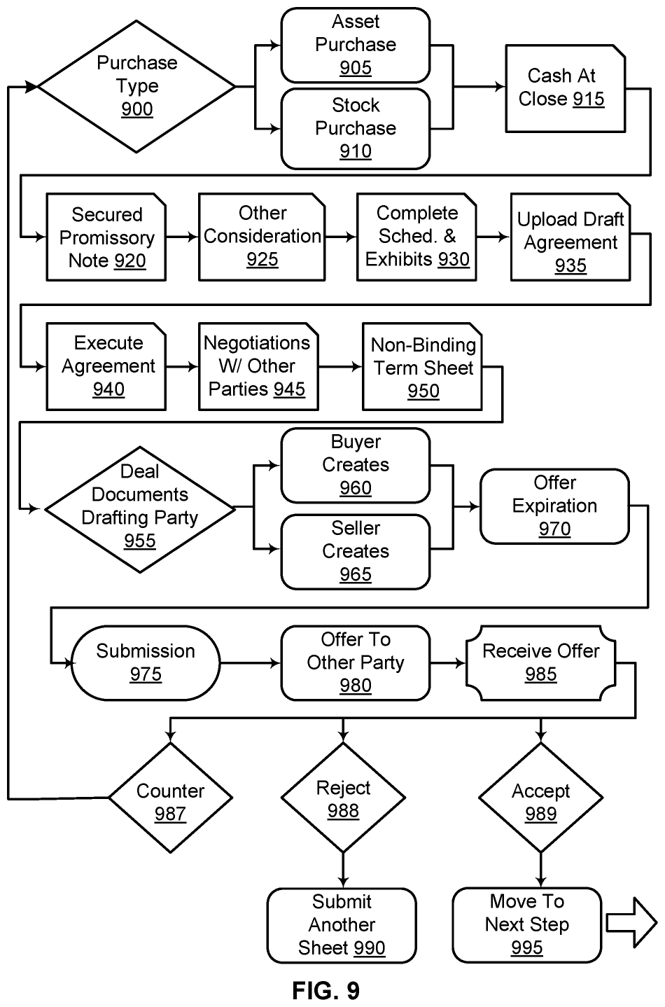

FIG. 9 shows an example of a transaction map for offers in accordance with aspects of the present disclosure. The example shown includes steps and options including purchase type 900, asset purchase 905, stock purchase 910, cash at close 915, secured promissory note 920, other consideration 925, completion of schedules and exhibits 930, upload draft of agreement 935, execute agreement 940, negotiations with other parties 945, non-binding nature of term sheet 950, deal documents drafting party 955, buyer creates documents 960, seller creates documents 965, expiration of offer 970, submission 975, offer goes to other party 980, receive offer 985, counter 987 (which returns the process to the beginning), reject 988, accept 989, submit another sheet 990 (if rejected), and move to next step 995 (if accepted).

Some of the functional units described in this specification have been labeled as modules, or components, to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set, or may be distributed over different locations including over different storage devices, and may exist, at least partially, merely as electronic signals on a system or network.

While the invention herein disclosed has been described by means of specific embodiments, examples, and applications thereof, numerous modifications and variations could be made thereto by those skilled in the art without departing from the scope of the invention set forth in the claims.

What is claimed is:

1. A system for communicating transaction steps to users, and confirming completion of the transaction steps, the system comprising:
a transaction steps database comprising a plurality of transaction step activities, each transaction step activity comprising at least one transaction category or suggested transaction category, and further comprising at least one of a buyer indicator or a seller indicator;
a responses database comprising a plurality of transaction responses;
a network coupled to the transaction steps database and the response database;
a transaction processor coupled to the network configured to execute the following steps:
receiving a transaction category;
retrieving all transaction step activities and suggested transaction step activities of the received transaction category;
transmitting the retrieved transaction step activities and suggested transaction step activities through the network to a buyer client when the buyer indicator is present and to a seller client when the seller indicator is present;
collecting responses from the buyer client and the seller client, wherein the responses include a transaction response, and further wherein the responses include an ignore indicator for each transaction step;
storing the transaction responses in the responses database; and
updating the transaction step activities in the transaction steps database with a number of times the ignore indicator has been set true;
the system further comprising a transaction refiner coupled to the network configured to execute the following steps:
reviewing the transaction steps database comprising evaluating the number of times the ignore indicator has been set true for each of the plurality of transaction step activities; and
re-categorizing transaction step activities of the transaction category to the suggested transaction category when the number of times the ignore indicator has been set true exceeds a threshold number.

2. The system of claim 1, the transaction processor further executing the following step:
receiving a new transaction step activity from the buyer client or the seller client, the new transaction step activity comprising at least one of the buyer indicator or the seller indicator, and the received transaction category.

3. The system of claim 1, the transaction processor further executing the following steps:
transmitting the new transaction step activity through the network to a buyer client when the buyer indicator is present and to a seller client when the seller indicator is present;
collecting a response to the new transaction step activity from at least one of the buyer client and the seller client, wherein the response includes a transaction response; and
storing the transaction response in the responses database.

4. The system of claim 1, the transaction processor further executing the following step:
removing transaction step categories of the suggested transaction category when the number of times the ignore indicator has been set true exceeds another threshold number from the transaction steps database.

5. The system of claim 1, wherein:
the network comprises an instant messaging network.

6. The system of claim 1, wherein:
the network comprises the internet.

7. The system of claim 1, wherein:
the network is configured to provide notifications for a mobile device.

8. The system of claim 1, wherein:
the network comprises a short message service (SMS) network.

9. A method for facilitating transactions, comprising:
receiving a transaction category;
retrieving all transaction step activities and suggested transaction step activities of the received transaction category;
transmitting the retrieved transaction step activities and suggested transaction step activities through the network to a buyer client when the buyer indicator is present and to a seller client when the seller indicator is present;
collecting responses from the buyer client and the seller client, wherein the responses include a transaction response, and further wherein the responses include an ignore indicator for each transaction step;
storing the transaction responses in the responses database; and
updating the transaction step activities in the transaction steps database with a number of times the ignore indicator has been set true.

10. The method of claim 9, further comprising:
reviewing the transaction steps database comprising evaluating the number of times the ignore indicator has been set true for each of the plurality of transaction step activities; and
re-categorizing transaction step activities of the transaction category to the suggested transaction category when the number of times the ignore indicator has been set true exceeds a threshold number.

11. The method of claim 9, further comprising:
receiving a new transaction step activity from the buyer client or the seller client, the new transaction step activity comprising at least one of the buyer indicator or the seller indicator, and the received transaction category.

12. The method of claim 9, further comprising:
transmitting the new transaction step activity through the network to a buyer client when the buyer indicator is present and to a seller client when the seller indicator is present;
collecting a response to the new transaction step activity from at least one of the buyer client and the seller client, wherein the response includes a transaction response; and
storing the transaction response in the responses database.

13. The method of claim 9, further comprising:
removing transaction step categories of the suggested transaction category when the number of times the ignore indicator has been set true exceeds another threshold number from the transaction steps database.

14. An apparatus for facilitating transactions, comprising: a transaction processor and a memory storing instructions and in electronic communication with the processor, the processor being configured to execute the instructions to:
receive a transaction category;
retrieve all transaction step activities and suggested transaction step activities of the received transaction category;
transmit the retrieved transaction step activities and suggested transaction step activities through the network to a buyer client when the buyer indicator is present and to a seller client when the seller indicator is present;
collect responses from the buyer client and the seller client, wherein the responses include a transaction response, and further wherein the responses include an ignore indicator for each transaction step;
store the transaction responses in the responses database; and
update the transaction step activities in the transaction steps database with a number of times the ignore indicator has been set true.

15. The apparatus of claim 14, the transaction processor being further configured to execute the instructions to:
review the transaction steps database comprising evaluating the number of times the ignore indicator has been set true for each of the plurality of transaction step activities; and
re-categorize transaction step activities of the transaction category to the suggested transaction category when the number of times the ignore indicator has been set true exceeds a threshold number.

16. The apparatus of claim 14, the transaction processor being further configured to execute the instructions to:
receive a new transaction step activity from the buyer client or the seller client, the new transaction step activity comprising at least one of the buyer indicator or the seller indicator, and the received transaction category.

17. The apparatus of claim 14, the transaction processor being further configured to execute the instructions to:
transmit the new transaction step activity through the network to a buyer client when the buyer indicator is present and to a seller client when the seller indicator is present;
collect a response to the new transaction step activity from at least one of the buyer client and the seller client, wherein the response includes a transaction response; and
store the transaction response in the responses database.

18. The apparatus of claim 14, the transaction processor being further configured to execute the instructions to:
remove transaction step categories of the suggested transaction category when the number of times the ignore indicator has been set true exceeds another threshold number from the transaction steps database.

19. A non-transitory computer readable medium storing code for facilitating transactions, the code comprising instructions executable by a processor to:
receive a transaction category;
retrieve all transaction step activities and suggested transaction step activities of the received transaction category;
transmit the retrieved transaction step activities and suggested transaction step activities through the network to a buyer client when the buyer indicator is present and to a seller client when the seller indicator is present;
collect responses from the buyer client and the seller client, wherein the responses include a transaction response, and further wherein the responses include an ignore indicator for each transaction step;
store the transaction responses in the responses database; and
update the transaction step activities in the transaction steps database with a number of times the ignore indicator has been set true.

20. The non-transitory computer-readable medium of claim 19, the code further comprising instructions executable by the processor to:
review the transaction steps database comprising evaluating the number of times the ignore indicator has been set true for each of the plurality of transaction step activities; and
re-categorize transaction step activities of the transaction category to the suggested transaction category when the number of times the ignore indicator has been set true exceeds a threshold number.

21. The non-transitory computer-readable medium of claim 19, the code further comprising instructions executable by the processor to:
receive a new transaction step activity from the buyer client or the seller client, the new transaction step activity comprising at least one of the buyer indicator or the seller indicator, and the received transaction category.

22. The non-transitory computer-readable medium of claim 19, the code further comprising instructions executable by the processor to:
transmit the new transaction step activity through the network to a buyer client when the buyer indicator is present and to a seller client when the seller indicator is present;
collect a response to the new transaction step activity from at least one of the buyer client and the seller client, wherein the response includes a transaction response; and
store the transaction response in the responses database.

23. The non-transitory computer-readable medium of claim 19, the code further comprising instructions executable by the processor to:
remove transaction step categories of the suggested transaction category when the number of times the ignore indicator has been set true exceeds another threshold number from the transaction steps database.
